(19) United States
(12) Patent Application Publication
(10) Pub. No.: US 2025/0158185 A1
(43) Pub. Date: May 15, 2025

(54) FIXING BRACKET AND INTEGRATED CABINET

(71) Applicant: Jinko Energy Storage Technology Co., Ltd., Haining (CN)

(72) Inventors: Shaorong GE, Haining (CN); Guochao CHEN, Haining (CN)

(21) Appl. No.: 18/731,377

(22) Filed: Jun. 3, 2024

(30) Foreign Application Priority Data
Nov. 14, 2023 (CN) 202311517143.5

(51) Int. Cl. H01M 50/204; H01M 50/262

(52) U.S. Cl. CPC H01M 50/204; H01M 50/262

(57) ABSTRACT

A fixing bracket and an integrated cabinet are provided. The fixing bracket includes a body portion and support portions arranged at the body portion. Along a first direction, at least part of one of the support portions protrudes from the body portion. The support portions are distributed at intervals along a second direction, and adjacent support portions are configured to clamp a target unit in the second direction, simplifying a fixing manner between the target unit and the fixing bracket, reducing a number of parts required to fix the target unit to the fixing bracket, reducing fixing costs of the target unit, simplifying a fixing operation on the target unit and the fixing bracket, and helping shorten a period for mounting the target unit to the fixing bracket.

### CROSS-REFERENCE TO RELATED APPLICATIONS

The present application claims priority to Chinese Application No. 202311517143.5, filed on Nov. 14, 2023, the content of which is incorporated herein by reference in its entirety.

### TECHNICAL FIELD

The present disclosure relates to the technical field of energy storage, and in particular, to a fixing bracket and an integrated cabinet.

### BACKGROUND

A battery cabinet is an important part of an energy storage system, and is configured to store excess electrical energy and supply power to electrical appliances to meet daily production requirements. The battery cabinet is provided therein with a battery pack for charging and discharging, various electronic components configured to monitor an operating state of the battery pack, and an integrated cabinet. A built-in power supply in the integrated cabinet is configured to supply power to the electronic components. Generally, the integrated cabinet includes a cabinet body and a fixing bracket mounted in the cabinet body. The fixing bracket includes a body portion and a support portion. The support portion is configured to carry the built-in power supply. A gap between adjacent support portions is relatively large. That is, along a height direction of the built-in power supply, the built-in power supply has one side abutting against the support portions and mounted and fixed with screws and another side having a large gap with the adjacent support portions.

The built-in power supply and the fixing bracket are mounted and fixed with screws, leading to a complicated mounting operation and a long mounting period of the built-in power supply.

### SUMMARY

The present disclosure provides a fixing bracket and an integrated cabinet, which can simplify the mounting operation of the built-in power supply and shorten the mounting period of the built-in power supply.

In a first aspect of the present disclosure, a fixing bracket is provided, and includes: a body portion; and a plurality of support portions arranged at the body portion, along a first direction, at least part of one of the plurality of support portions protruding from the body portion. The plurality of support portions are distributed at intervals along a second direction perpendicular to the first direction, and in the second direction, adjacent support portions of the plurality of support portions are configured to clamp a target unit. In the present disclosure, the target unit is clamped and fixed by two adjacent support portions in the second direction, thereby simplifying a fixing manner between the target unit and the fixing bracket, reducing a number of parts required to fix the target unit to the fixing bracket, reducing fixing costs of the target unit, simplifying a fixing operation on the target unit and the fixing bracket, and helping shorten a period for mounting the target unit to the fixing bracket.

In some embodiment of the present disclosure, one of the plurality of support portions includes a support body and a first guide portion, the support body extends along a third direction, and in the third direction, the first guide portion is located on one side of the support body, and in the third direction, a plurality of first guide portions are located on a same side of the fixing bracket. The first guide portion extends obliquely, an angle between the first guide portion and the support body is an obtuse angle, the third direction is perpendicular to the first direction and perpendicular to the second direction, and an inclination direction of the first guide portion is located in a plane defined by the second direction and the third direction.

In some embodiment of the present disclosure, adjacent first guide portions have a same bending direction in the second direction, one first guide portion is configured to abut against one side of the target unit in the second direction and the support body of a support portion adjacent to the one first guide portion is configured to abut against another side of the target unit in the second direction; and/or adjacent first guide portions have opposite bending directions in the second direction, one support body is configured to abut against one side of the target unit in the second direction, and a support body of a support portion adjacent to the one support body is configured to abut against another side of the target unit in the second direction.

In some embodiment of the present disclosure, one of the plurality of support portions further includes a second guide portion, and in the third direction, the second guide portion is formed on one side of the support body away from the first guide portion; and the second guide portion extends obliquely, an angle between the second guide portion and the support body is an obtuse angle, and an inclination direction of the second guide portion is located in the plane defined by the second direction and the third direction.

In some embodiment of the present disclosure, in the second direction, a distance H between parts of two adjacent support portions configured to abut against a same target unit in the second direction satisfies: 87.5 mm≤H≤90.5 mm.

In some embodiment of the present disclosure, one support portion of the plurality of support portions extends along a third direction that is perpendicular to the first direction and perpendicular to the second direction, and along the third direction, only one support portion is provided; and a length L1 of the one support portion in the third direction satisfies: 410 mm≤L1≤434 mm.

In some embodiment of the present disclosure, one support portion of the plurality of support portions extends along a third direction that is perpendicular to the first direction and perpendicular to the second direction, and along the third direction, multiple support portions are provided; and a length L2 of one of the multiple support portions in the third direction satisfies: 30 mm≤L2≤54 mm, and a distance L3 between adjacent ones of the multiple support portions in the third direction satisfies: 131 mm≤L3≤135 mm.

In some embodiment of the present disclosure, in the first direction, one of the support portion protrudes from the body portion by a distance L4 satisfying: 16 mm≤L4≤20 mm.

In a second aspect of the present disclosure, an integrated cabinet is provided, including a cabinet body, a cabinet door, the fixing bracket in any one of the embodiments described above, and at least one target unit. The cabinet door is mounted to the cabinet body; the fixing bracket is mounted to the cabinet body. The target unit is clamped and fixed by the fixing bracket. In the present disclosure, the target unit is clamped and fixed by the support portion of the fixing bracket, simplifying a fixing manner between the target unit and the fixing bracket and between the target unit and the cabinet body, reducing fixing costs of the target unit, simplifying a fixing operation on the target unit, and helping shorten a period for mounting the target unit.

In some embodiments, the support portion includes a guide portion, and along a mounting direction of the target unit, at least part of the guide portion is located on a side of the fixing bracket close to the cabinet door.

It should be understood that the above general description and the following detailed description are only exemplary and do not limit the present disclosure.

### BRIEF DESCRIPTION OF DRAWINGS

FIG. 1 is a schematic structural diagram of an integrated cabinet according to some embodiments of the present disclosure;

FIG. 2 is a schematic structural diagram of FIG. 1 after a cabinet door is removed;

FIG. 3 is a schematic structural diagram of a connection between a cabinet body and a fixing bracket of the integrated cabinet in FIG. 1;

FIG. 4 is a schematic structural diagram of the fixing bracket in FIG. 3 according to some embodiments of the present disclosure;

FIG. 5 is a front view of FIG. 4;

FIG. 6 is an enlarged view of Part A in FIG. 5;

FIG. 7 is a front view of the fixing bracket in FIG. 3 according to some embodiments of the present disclosure;

FIG. 8 is an enlarged view of Part B in FIG. 7;

FIG. 9 is a schematic structural diagram of the fixing bracket in FIG. 3 according to some embodiments of the present disclosure;

FIG. 10 is a front view of FIG. 9;

FIG. 11 is an enlarged view of Part D in FIG. 10; and

FIG. 12 is an enlarged view of Part E in FIG. 10.

### REFERENCE SIGNS

1: fixing bracket;
11: body portion;
111: first plate body;
112: second plate body;
113: third plate body;
114: mounting portion;
115: process hole;
12: support portion;
121: clamping space;
122: support body;
123: first guide portion;
124: second guide portion;
2: cabinet body;
21: cavity;
3: cabinet door;
4: built-in power supply.

The accompanying drawings, which are incorporated in and constitute a part of the specification, illustrate embodiments consistent with the present disclosure and together with the description serve to explain the principles of the present disclosure.

### DESCRIPTION OF EMBODIMENTS

In order to better illustrate the technical solutions of the present disclosure, the embodiments of the present disclosure will be described in detail below with reference to the accompanying drawings.

It should be noted that the described embodiments are only some of, rather than all of the embodiments of the present disclosure. Based on the embodiments in the present disclosure, all other embodiments obtained by those of ordinary skill in the art without making creative efforts shall fall within a protection scope of the present disclosure.

The terms used in the embodiments of the present disclosure are for the purpose of describing embodiments only and are not intended to limit the present disclosure. As used in the embodiments of the present disclosure and the appended claims, the singular forms “a,” “an”, and “the” are intended to include the plural forms as well, unless the context clearly dictates otherwise.

It should be understood that the term “and/or” used herein is merely an association relationship describing associated objects, indicating that there may be three relationships. For example, A and/or B may indicate that there are three cases of A alone, A and B together, and B alone. In addition, the character “/” herein generally indicates that the related objects before and after the character form an “or” relationship.

It should be noted that, the expressions such as “upper”, “lower”, “left”, “right” and the like mentioned in embodiments of the present disclosure are described with reference to the placement status in the accompanying drawings, and should not be construed as limiting embodiments of the present disclosure. In addition, it should also be understood that, in the context, while referring to an element being formed “above” or “below” another element, it is possible that the element is directly formed “above” or “below” the other element, it is also possible that the element is formed “above” or “below” the other element via an intermediate element.

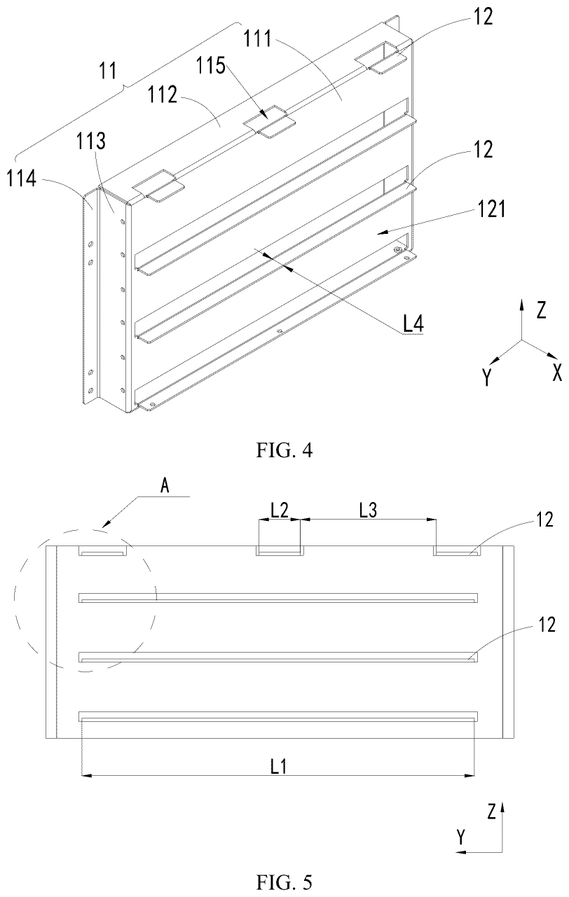

In a first aspect, some embodiments of the present disclosure provide a fixing bracket 1. As shown in FIG. 4, the fixing bracket 1 includes a body portion 11 and a support portion 12. The support portion 12 is arranged on the body portion 11. Along a first direction X, at least part of the support portion 12 protrudes from the body portion 11. A plurality of support portions 12 are provided. The plurality of support portions 12 are distributed at intervals along a second direction Z. In the second direction Z, adjacent support portions 12 are configured to clamp a target unit. The target unit includes, but is not limited to, a box-shaped member, a plate-shaped member, an electrical appliance, a power supply, and the like. The specific type and the function of the target unit are not limited in the embodiments of the present disclosure. The fixing bracket 1 includes a length direction, a width direction, and a height direction that are perpendicular to each other. The first direction X and the second direction Z are respectively parallel to two of the length direction, the width direction, and the height direction. For example, the first direction X is parallel to the height direction of the fixing bracket 1, the second direction Z is parallel to the width direction of the fixing bracket 1, and a third direction Y is parallel to the length direction of the fixing bracket 1.

The support portion 12 protrudes from the body portion 11 in the first direction X. A plurality of support portions 12 are distributed at intervals along the second direction Z. A clamping space 121 is formed between two adjacent support portions 12. The clamping space 121 is configured to accommodate at least part of the target unit. Moreover, in the second direction Z, two sides of the target unit abut against the two adjacent support portions 12 respectively, so that the target unit is clamped and fixed by the two adjacent support portions 12 in the second direction Z, thereby simplifying a fixing manner between the target unit and the fixing bracket 1, simplifying a number of parts required to fix the target unit to the fixing bracket 1, and reducing fixing costs of the target unit. Moreover, it simplifies a fixing operation on the target unit and the fixing bracket 1, thereby helping reduce a period for mounting the target unit to the fixing bracket 1.

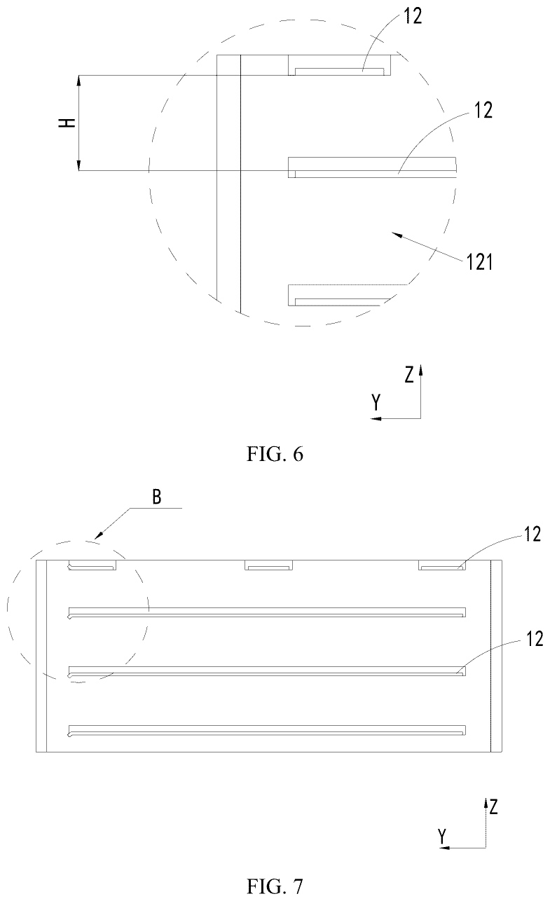

In some embodiments, as shown in FIG. 4 to FIG. 6, a contour of a projection of the support portion 12 in the first direction X is in a shape of a rectangle, so as to facilitate machining of the support portion 12, thereby reducing machining costs and a machining period of the fixing bracket 1.

In some embodiments, as shown in FIG. 7 to FIG. 12, one or two ends of the support portion 12 are bent to form a guide portion, so that the contour of the projection of the support portion 12 in the first direction X is in an L-like shape, a Z-like shape, a U-like shape, or the like. When the target unit is inserted between two adjacent support portions 12 in the second direction Z, the guide portion can correct and guide a moving direction of the target unit, so that the target unit moves along an inclination direction of the guide portion until the target unit is guided into the clamping space 121. In an insertion direction of the target unit, a risk of impossible insertion of the support portion 12 into the clamping space 121 caused by abutment of an edge of the target unit with the target unit is reduced, and a risk of damage to a clamping portion and the target unit is reduced, thereby simplifying an operation of inserting the target unit into the clamping space 121 and helping prolong the service life of the support portion 12 and the target unit.

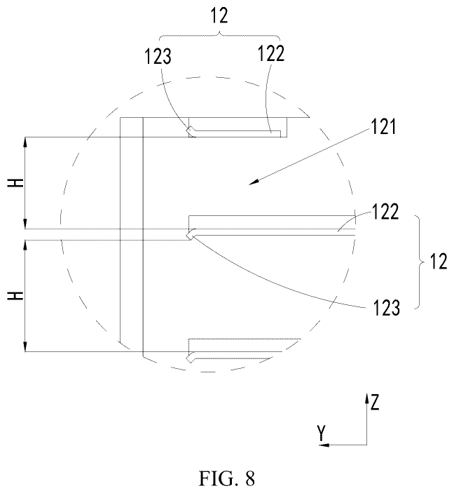

When the support portion 12 is provided with the guide portion, as shown in FIG. 7 and FIG. 8, the support portion 12 includes a support body 122 and a first guide portion 123, the support body 122 extends along the third direction Y, the first guide portion 123 extends obliquely, and an angle between the first guide portion 123 and the support body 122 is an obtuse angle. In the third direction Y, the first guide portion 123 is located on one side of the support body 122, to simplify a structure of the support portion 12, reduce machining costs of the support portion 12, and shorten a machining period of the support portion 12. When one fixing bracket 1 is configured to clamp and fix a plurality of target units distributed along the second direction Z, a plurality of first guide portions 123 are located on a same side of the fixing bracket 1, to reduce a risk of damage to the target unit or the support portion 12 caused by lack of guidance during the mounting of some target units.

As shown in FIG. 8, for two adjacent first guide portions 123 in the second direction Z, one first guide portion 123 bends upwards in the second direction Z, and the other one first guide portion 123 bends downwards in the second direction Z. That is, two adjacent first guide portions 123 in the second direction Z have opposite bending directions in the second direction Z, so that when inserting the target unit into the clamping space 121, the first guide portions 123 have guiding effects on two sides of the target unit in the second direction Z, to further enhance the guiding effects of the first guide portions 123. In this case, in the second direction Z, the target unit has one side abutting against the support body 122 and another side abutting against the support body 122 adjacent thereto. And/or, as shown in FIG. 8, two adjacent first guide portions 123 in the second direction Z have a same bending direction in the second direction Z, that is, the two adjacent first guide portions 123 both bend downwards in the second direction Z or the two adjacent first guide portions 123 both bend upwards in the second direction Z, so as to facilitate machining of the fixing bracket 1, thereby shortening a machining period of the fixing bracket 1. In this case, in the second direction Z, the target unit has one side abutting against the first guide portion 123 and another side abutting against the support body 122 on the support portion 12 adjacent thereto.

In some embodiments, as shown in FIG. 7, in the third direction Y, a side of the support body 122 away from the first guide portion 123 is not provided with a guide portion, to simplify the structure of the support portion 12 and reduce the machining costs of the support portion 12.

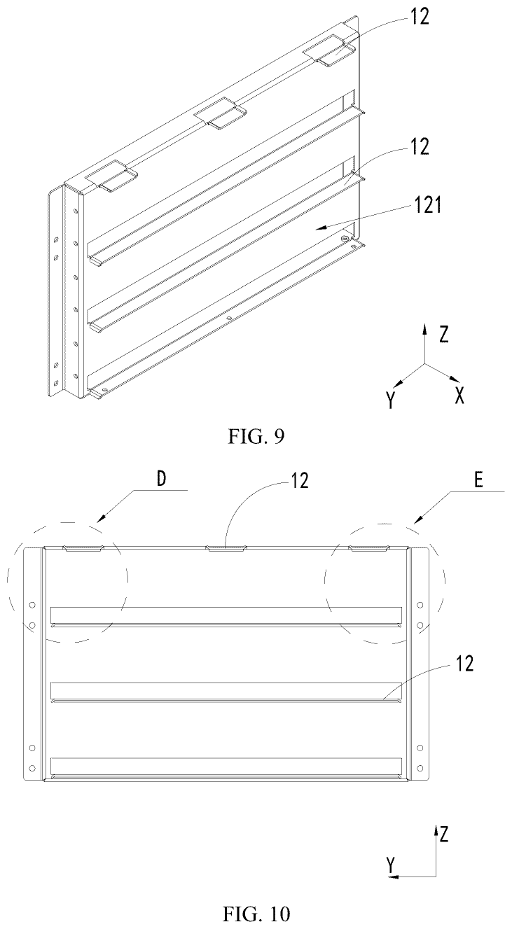

In some embodiments, as shown in FIG. 9 to FIG. 12, in the third direction Y, a side of the support body 122 away from the first guide portion 123 is provided with a second guide portion 124. That is, the support body 122 is provided with guide portions on two sides in the third direction Y. During the insertion of the target unit into the clamping space 121 from left to right or from right to left in the third direction Y, the guide portions can guide movement of the target unit, thereby reducing limitations of mounting positions of the guide portions on an insertion direction of the target unit and increasing flexibility of a mounting direction of the fixing bracket 1.

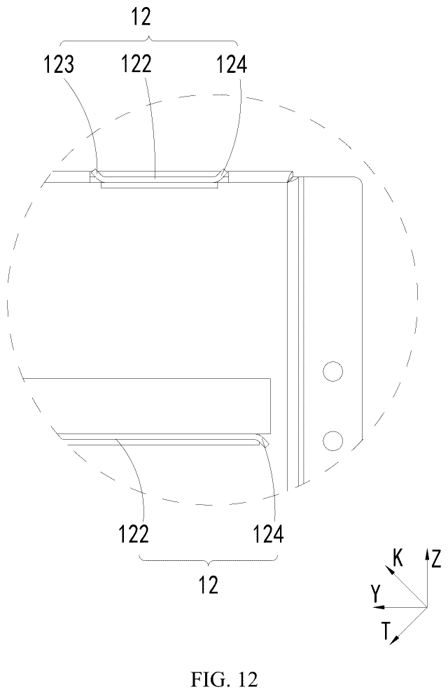

As shown in FIG. 12, for two adjacent second guide portions 124 in the second direction Z, one second guide portion 124 bends upwards in the second direction Z, and the other one second guide portion 124 bends downwards in the second direction Z. That is, the two adjacent second guide portions 124 in the second direction Z have opposite bending directions in the second direction Z, so that when inserting the target unit into the clamping space 121, the second guide portions 124 have guiding effects on two sides of the target unit in the second direction Z, to further enhance the guiding effects of the second guide portions 124. In this case, in the second direction Z, the target unit has one side abutting against the support body 122 and the other side abutting against the support body 122 adjacent thereto. And/or, as shown in FIG. 12, two adjacent second guide portions 124 in the second direction Z have a same bending direction in the second direction Z, that is, the two adjacent second guide portions 124 both bend downwards in the second direction Z or the two adjacent second guide portions 124 both bend upwards in the second direction Z, so as to facilitate machining of the fixing bracket 1, thereby shortening a machining period of the fixing bracket 1. In this case, in the second direction Z, the target unit has one side abutting against the second guide portion 124 and the other side abutting against the support body 122 on the support portion 12 adjacent thereto.

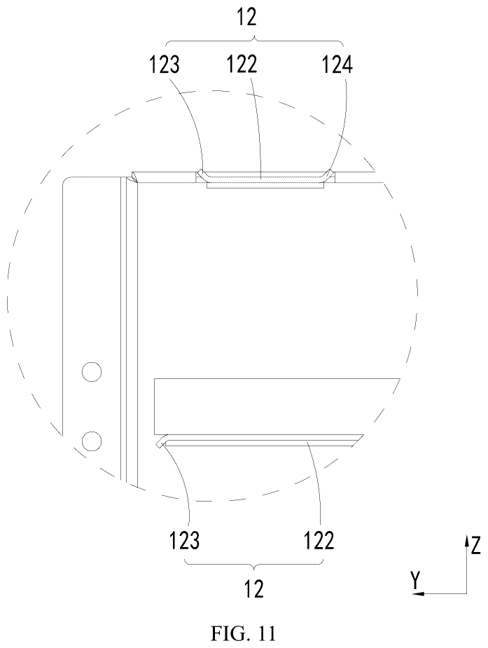

In addition, in some embodiments, for the first guide portion 123 and the second guide portion 124 of a same support portion 12, one of the first guide portion 123 and the second guide portion 124 bends downwards in the second direction Z, and the other one of the first guide portion 123 and the second guide portion 124 bends downwards in the second direction Z. That is, the first guide portion 123 and the second guide portion 124 of a same support portion 12 have opposite bending directions in the second direction Z. Moreover, inclination directions of the first guide portion 123 and the second guide portion 124 may be the same or different, so that the contour of the projection of the support portion 12 in the first direction X is in a Z-like shape. In some embodiments, as shown in FIG. 10, FIG. 11, and FIG. 12, the first guide portion 123 and the second guide portion 124 of a same support portion 12 have a same bending direction in the second direction Z. That is, both the first guide portion 123 and the second guide portion 124 bend downwards in the second direction Z, or both the first guide portion 123 and the second guide portion 124 bend upwards in the second direction Z. Moreover, inclination directions of the first guide portion 123 and the second guide portion 124 may be the same or different, so that the contour of the projection of the support portion 12 in the first direction X is in a U-like shape. In an embodiment, the first guide portion 123 and the second guide portion 124 of a same support portion 12 are symmetrical to each other with respect to the second direction Z. That is, of a same support portion 12, an angle between the first guide portion 123 and the support body 122 is equal to an angle between the second guide portion 124 and the support body 122, thereby further reducing the machining costs of the support portion 12.

In any one of the above embodiments, in the second direction Z, a distance H between parts of two adjacent support portions 12 configured to abut against a same target unit in the second direction Z satisfies: 87.5 mm≤H≤90.5 mm, which may be 87.5 mm, 87.6 mm, 87.7 mm, 87.8 mm, 87.9 mm, 88 mm, 88.1 mm, 88.2 mm, 88.3 mm, 88.4 mm, 88.5 mm, 88.6 mm, 88.7 mm, 88.8 mm, 88.9 mm, 89 mm, 89.1 mm, 89.2 mm, 89.3 mm, 89.4 mm, 89.5 mm, or the like. If this distance is too small, that is, H<87.5 mm, there is a risk that a dimension of the clamping space 121 in the second direction Z is smaller than a dimension of the target unit in the second direction Z, and thus there is a risk that the target unit cannot be inserted into the clamping space 121. If this distance is too large, that is, H>90.5 mm, there is a risk that the dimension of the clamping space 121 in the second direction Z is greater than the dimension of the target unit in the second direction Z, and thus there is a risk that the target unit cannot be clamped and fixed by the two adjacent support portions 12. Therefore, a condition of 87.5 mm≤H≤90.5 mm can improve stability of clamping the target unit by the clamping portions and facilitate smooth insertion of the target unit into the clamping space 121, simplifying the mounting operation of the target unit.

In any one of the above embodiments, the support portion 12 and the body portion 11 are separately formed and fixedly connected to each other, to facilitate machining of the support portion 12 and the body portion 11, thereby reducing machining costs of the fixing bracket 1. Alternatively, the support portion 12 and the body portion 11 are integrally formed, that is, part of the body portion 11 is bent to form the support portion 12, to reduce material costs of the fixing bracket 1. At the same time, during the integral formation of the support portion 12 and the body portion 11, there is a need to first form a process hole 115 as shown in FIG. 4 in the body portion 11 and then form the support portion 12 by bending. Therefore, the integral formation of the support portion 12 and the body portion 11 can also help reduce an overall weight of the fixing bracket 1 and facilitate mounting and transportation of the fixing bracket 1.

In any one of the above embodiments, as shown in FIG. 5, in the third direction Y, one support portion 12 is provided, to simplify the structure of the fixing bracket 1 and reduce the machining costs of the fixing bracket 1. A length L1 of the support portion 12 in the third direction Y satisfies: 410 mm≤L1≤434 mm, which may be 410 mm, 412 mm, 414 mm, 416 mm, 418 mm, 420 mm, 422 mm, 424 mm, 426 mm, 428 mm, 430 mm, 432 mm, 434 mm, or the like. If the length of the support portion 12 in the third direction Y is too small, that is, L1≤410 mm, a length of the support portion 12 configured to abut against the target unit in the third direction Y is too small, resulting in a small clamping force of the support portion 12 on the target unit. If the length of the support portion 12 in the third direction Y is too great, that is, L1>434 mm, material costs of the support portion 12 are increased. Therefore, a condition of 410 mm≤L1≤434 mm can reduce the material costs of the fixing bracket 1 and improve the clamping force of the support portion 12 on the target unit, to improve stability of the clamping of the target unit by the fixing bracket 1.

In any one of the above embodiments, as shown in FIG. 5, in the third direction Y, a plurality of support portions 12 are distributed at intervals. When the support portions 12 and the body portion 11 are separately formed and fixedly connected to each other, the distribution of the plurality of support portions 12 at intervals can increase a mounting space of the support portions 12 and reduce a risk of interference between adjacent support portions 12 under influences of factors such as mounting errors and machining errors. When the support portions 12 and the body portion 11 are integrally formed, the distribution of the plurality of support portions 12 at intervals reduces a dimension of the process hole 115 in the third direction Y, thereby improving structural strength of the body portion 11 and reducing a risk of deformation of and damage to the body portion 11.

As shown in FIG. 5, a length L2 of the support portion 12 in the third direction Y satisfies: 30 mm≤L2≤54 mm, which may be 30 mm, 32 mm, 34 mm, 36 mm, 38 mm, 40 mm, 42 mm, 44 mm, 46 mm, 48 mm, 50 mm, 52 mm, 54 mm, or the like. If L2<30 mm, strength of the support portion 12 is weak, and there is a risk of deformation of and damage to the support portion 12. If L2>54 mm, when the support portion 12 and the body portion 11 are separately formed and fixedly connected to each other, mounting difficulty of the support portion 12 in the third direction Y is increased, and when the support portion 12 and the body portion 11 are integrally formed, the structural strength of the body portion 11 is reduced. Therefore, a condition of 30 mm≤L2≤54 mm can improve structural strength of the support portion 12 and the fixing bracket 1 and facilitate mounting and machining of the support portion 12.

In addition, as shown in FIG. 5, in the third direction Y, a distance L3 between adjacent support portions 12 satisfies: 131 mm≤L3≤135 mm, which may be 131 mm, 131.5 mm, 132 mm, 132.5 mm, 133 mm, 133.5 mm, 134 mm, 134.5 mm, 135 mm, or the like. If L3<131 mm, when the support portion 12 and the body portion 11 are separately formed and fixedly connected to each other, mounting difficulty of the support portion 12 in the third direction Y is increased, and when the support portion 12 and the body portion 11 are integrally formed, the structural strength of the body portion 11 is reduced. If L3>135 mm, on a premise of satisfying structural strength of the support portion 12 and a support force of the support portion 12 on the target unit, an overall dimension of the fixing bracket 1 in the third direction Y is large, which is not conducive to mounting and transportation of the fixing bracket 1. Therefore, a condition of 131 mm≤L3≤135 mm can improve the structural strength of the support portion 12 and the fixing bracket, prolong the service life, and help reduce the overall dimension of the fixing bracket 1.

In any one of the above embodiments, as shown in FIG. 4, in the first direction X, a distance L4 of the support portion 12 protruding from the body portion 11 satisfies: 16 mm≤L4≤20 mm, which may be 16 mm, 16.5 mm, 17 mm, 17.5 mm, 18 mm, 18.5 mm, 19 mm, 19.5 mm, 20 mm, or the like. If L4≤16 mm, a dimension of the support portion 12 configured to abut against the target unit in the first direction X is small, so that a clamping force of the support portion 12 on the target unit is small. If L4>20 mm, when the support portion 12 and the body portion 11 are separately formed and fixedly connected to each other, the material costs of the support portion 12 are increased, and when the support portion 12 and the body portion 11 are integrally formed, a dimension of the process hole 115 in the second direction Z is large, which reduces the structural strength of the body portion 11. Therefore, a condition of 16 mm≤L4≤20 mm can increase a clamping force of the fixing bracket 1 on the target unit, improve stability of the mounting of the target unit on the fixing bracket 1, help reduce the material costs of the fixing bracket 1, and improve structural strength of the fixing bracket 1.

In any one of the above embodiments, as shown in FIG. 4, the body portion 11 includes a first plate body 111, a second plate body 112, and a third plate body 113, the first plate body 111 is formed in a plane defined by the second direction Z and the third direction Y, and the second plate body 112 is formed in a plane defined by the first direction X and the third direction Y. Moreover, along the second direction Z, the second plate body 112 is arranged oppositely on each of two sides of the first plate body 111, and the third plate body 113 is formed in a plane defined by the first direction X and the second direction Z. Furthermore, along the third direction Y, the third plate body 113 is arranged oppositely on each of two sides of the first plate body 111. The first plate body 111, the second plate body 112, and the third plate body 113 form a box-shaped member, to improve the structural strength of the body portion 11. Along the first direction X, the support portion 12 extends in a direction away from the second plate body 112 and the third plate body 113. As shown in FIG. 4, the body portion 11 further includes a mounting portion 114, the mounting portion 114 is connected to the third plate body 113 and/or a fourth plate body, and the fixing bracket 1 is mounted and fixed through the mounting portion 114, to simplify a mounting structure of the fixing bracket 1.

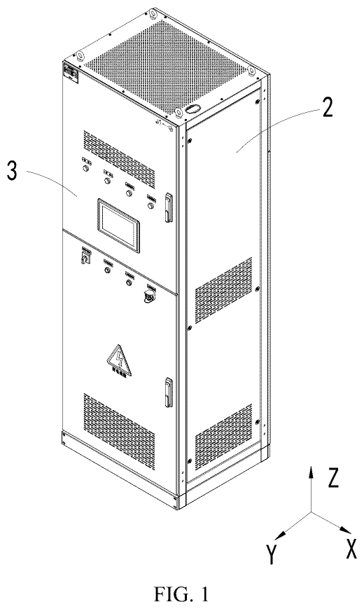

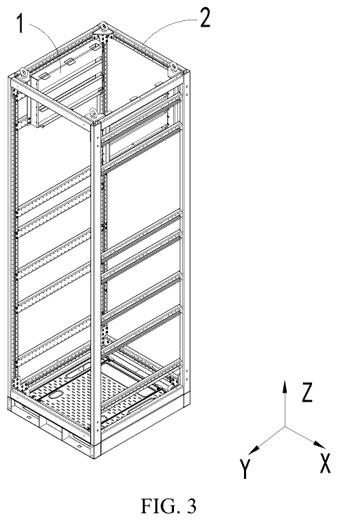

In a second aspect, some embodiments of the present disclosure provide an integrated cabinet. As shown in FIG. 1 to FIG. 3, the integrated cabinet includes a cabinet body 2, a cabinet door 3 mounted on the cabinet body 2, and the fixing bracket 1 described in any one of the above embodiments. The cabinet body 2 is provided therein with a cavity 21. The cabinet door 3 is configured to open or seal the cavity 21. The fixing bracket 1 is mounted in the cavity 21. The cavity 21 is provided therein with a variety of electronic components. The electronic components are the target units described above, including, but not limited to, a built-in power supply 4, a transformer, a DC-AC converter, and the like. The fixing bracket 1 is configured to fix one of the electronic components. For example, if the fixing bracket 1 is configured to fix the built-in power supply 4, the built-in power supply 4 is clamped and fixed by the support portion 12 of the fixing bracket 1, thereby simplifying fixing manners between the built-in power supply 4 and the fixing bracket 1 and between the built-in power supply 4 and the cabinet body 2, and thus reducing fixing costs of the built-in power supply 4, and also simplifying the fixing operation of the built-in power supply 4, helping shorten a mounting period of the built-in power supply 4.

During the insertion of the built-in power supply 4 into the clamping space 121, in the third direction Y, the built-in power supply 4 may be inserted into the cavity 21 from one side where the cabinet door 3 is located. Therefore, along a mounting direction of the built-in power supply 4, that is, along the third direction Y, at least part of the guide portion is located on a side of the fixing bracket 1 close to the cabinet door 3, to improve accuracy of an insertion direction of the built-in power supply 4, thereby simplifying the fixing operation of the built-in power supply 4.

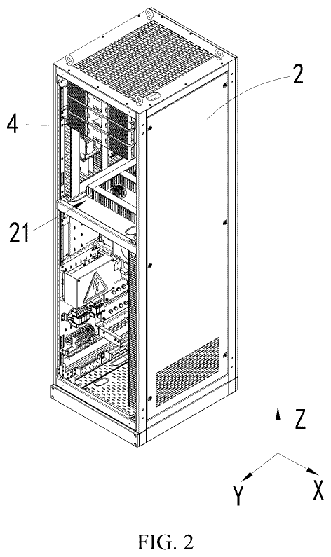

As shown in FIG. 2, the cavity 21 of the integrated cabinet is divided into at least two cavities, and different types of electronic components may be mounted in different cavities, to improve operational stability of the electronic components.

The above-described embodiments are merely preferred embodiments of the present disclosure and are not intended to limit the present disclosure. Various changes and modifications can be made to the present disclosure by those skilled in the art. Any modifications, equivalent substitutions and improvements made within the principle of the present disclosure shall fall into the protection scope of the present disclosure.

What is claimed is:

1. A fixing bracket (1), comprising:
a body portion (11); and
a plurality of support portions (12) arranged at the body portion (11), wherein along a first direction (X), at least part of one of the plurality of support portions (12) protrudes from the body portion (11);
wherein the plurality of support portions (12) are distributed at intervals along a second direction (Z) perpendicular to the first direction (X), and in the second direction (Z), adjacent support portions (12) of the plurality of support portions (12) are configured to clamp a target unit.

2. The fixing bracket according to claim 1,
wherein one of the plurality of support portions (12) comprises a support body (122) and a first guide portion (123), wherein the support body (122) extends along a third direction (Y), and in the third direction (Y), the first guide portion (123) is located on one side of the support body (122), and in the third direction (Y), a plurality of first guide portions (123) are located on a same side of the fixing bracket (1); and
wherein the first guide portion (123) extends obliquely, an angle between the first guide portion (123) and the support body (122) is an obtuse angle, the third direction (Y) is perpendicular to the first direction (X) and perpendicular to the second direction (Z), and an inclination direction of the first guide portion (123) is located in a plane defined by the second direction (Z) and the third direction (Y).

3. The fixing bracket according to claim 2,
wherein adjacent first guide portions (123) have a same bending direction in the second direction (Z), one first guide portion (123) is configured to abut against one side of the target unit in the second direction (Z), and the support body (122) of a support portion (12) adjacent to the one first guide portion (123) is configured to abut against another side of the target unit in the second direction (Z); and/or
wherein adjacent first guide portions (123) have opposite bending directions in the second direction (Z), one support body (122) is configured to abut against one side of the target unit in the second direction (Z), and a support body (122) of a support portion (12) adjacent to the one support body (122) is configured to abut against another side of the target unit in the second direction (Z).

4. The fixing bracket according to claim 2,
wherein one of the plurality of support portions (12) further comprises a second guide portion (124), and in the third direction (Y), the second guide portion (124) is formed on one side of the support body (122) away from the first guide portion (123); and
the second guide portion (124) extends obliquely, an angle between the second guide portion (124) and the support body (122) is an obtuse angle, and an inclination direction of the second guide portion (124) is located in the plane defined by the second direction (Z) and the third direction (Y).

5. The fixing bracket according to claim 4, wherein the first guide portion (123) and the second guide portion (124) of a same support portion (12) have opposite bending directions in the second direction Z.

6. The fixing bracket according to claim 4, wherein the first guide portion (123) and the second guide portion (124) of a same support portion (12) have a same bending direction in the second direction Z.

7. The fixing bracket according to claim 4, wherein of a same support portion (12), an angle between the first guide portion (123) and the support body (122) is equal to an angle between the second guide portion (124) and the support body (122).

8. The fixing bracket according to claim 1, wherein in the second direction (Z), a distance H between parts of two adjacent support portions (12) configured to abut against a same target unit in the second direction (Z) satisfies: 87.5 mm≤H≤90.5 mm.

9. The fixing bracket according to claim 1,
wherein one support portion (12) of the plurality of support portions (12) extends along a third direction (Y) that is perpendicular to the first direction (X) and perpendicular to the second direction (Z), and along the third direction (Y), only one support portion (12) is provided; and
wherein a length L1 of the one support portion (12) in the third direction (Y) satisfies: 410 mm≤L1≤434 mm.

10. The fixing bracket according to claim 1,
wherein one support portion (12) of the plurality of support portions (12) extends along a third direction (Y) that is perpendicular to the first direction (X) and perpendicular to the second direction (Z), and along the third direction (Y), multiple support portions (12) are provided; and
wherein a length L2 of one of the multiple support portions (12) in the third direction (Y) satisfies: 30 mm≤L2≤54 mm, and a distance L3 between adjacent ones of the multiple support portions (12) in the third direction (Y) satisfies: 131 mm≤L3≤135 mm.

11. The fixing bracket according to claim 1, wherein in the first direction (X), one of the support portion (12) protrudes from the body portion (11) by a distance L4 satisfying: 16 mm≤L4≤20 mm.

12. An integrated cabinet, comprising:
a cabinet body (2);
a cabinet door (3) mounted to the cabinet body (2);
the fixing bracket (1) according to claim 1, wherein the fixing bracket (1) is mounted to the cabinet body (2); and
at least one target unit clamped and fixed by the fixing bracket (1).

13. The integrated cabinet according to claim 12, wherein one of the plurality of support portions (12) comprises a guide portion, and along a mounting direction of one of the at least one target unit, at least part of the guide portion is located on a side of the fixing bracket (1) close to the cabinet door (3).

14. The integrated cabinet according to claim 12,
wherein one of the plurality of support portions (12) comprises a support body (122) and a first guide portion (123), wherein the support body (122) extends along a third direction (Y), and in the third direction (Y), the first guide portion (123) is located on one side of the support body (122), and in the third direction (Y), a plurality of first guide portions (123) are located on a same side of the fixing bracket (1); and
wherein the first guide portion (123) extends obliquely, an angle between the first guide portion (123) and the support body (122) is an obtuse angle, the third direction (Y) is perpendicular to the first direction (X) and perpendicular to the second direction (Z), and an inclination direction of the first guide portion (123) is located in a plane defined by the second direction (Z) and the third direction (Y).

15. The integrated cabinet according to claim 14,
wherein adjacent first guide portions (123) have a same bending direction in the second direction (Z), one first guide portion (123) is configured to abut against one side of the target unit in the second direction (Z), and the support body (122) of a support portion (12) adjacent to the one first guide portion (123) is configured to abut against another side of the target unit in the second direction (Z); and/or
wherein adjacent first guide portions (123) have opposite bending directions in the second direction (Z), one support body (122) is configured to abut against one side of the target unit in the second direction (Z), and a support body (122) of a support portion (12) adjacent to the one support body (122) is configured to abut against another side of the target unit in the second direction (Z).

16. The integrated cabinet according to claim 14,
wherein one of the plurality of support portions (12) further comprises a second guide portion (124), and in the third direction (Y), the second guide portion (124) is formed on one side of the support body (122) away from the first guide portion (123); and
the second guide portion (124) extends obliquely, an angle between the second guide portion (124) and the support body (122) is an obtuse angle, and an inclination direction of the second guide portion (124) is located in the plane defined by the second direction (Z) and the third direction (Y).

17. The integrated cabinet according to claim 12, wherein in the second direction (Z), a distance H between parts of two adjacent support portions (12) configured to abut against a same target unit in the second direction (Z) satisfies: 87.5 mm≤H≤90.5 mm.

18. The integrated cabinet according to claim 12,
wherein one support portion (12) of the plurality of support portions (12) extends along a third direction (Y) that is perpendicular to the first direction (X) and perpendicular to the second direction (Z), and along the third direction (Y), only one support portion (12) is provided; and
wherein a length L1 of the one support portion (12) in the third direction (Y) satisfies: 410 mm≤L1≤434 mm.

19. The integrated cabinet according to claim 12,
wherein one support portion (12) of the plurality of support portions (12) extends along a third direction (Y) that is perpendicular to the first direction (X) and perpendicular to the second direction (Z), and along the third direction (Y), multiple support portions (12) are provided; and
wherein a length L2 of one of the multiple support portions (12) in the third direction (Y) satisfies: 30 mm≤L2≤54 mm, and a distance L3 between adjacent ones of the multiple support portions (12) in the third direction (Y) satisfies: 131 mm≤L3≤135 mm.

20. The integrated cabinet according to claim 12, wherein in the first direction (X), one of the support portion (12) protrudes from the body portion (11) by a distance L4 satisfying: 16 mm≤L4≤20 mm.
